(19) United States
(12) Patent Application Publication
(10) Pub. No.: US 2002/0160787 A1
(43) Pub. Date: Oct. 31, 2002

(54) Communications system and related method for determining a position of a mobile station

(75) Inventors: Byron Hua Chen, Whippany, NJ (US); Ren Da, Bernards Township, NJ (US); Alex Matusevich, Morris Plains, NJ (US); Ibrahim Tekin, Summit, NJ (US)

Correspondence Address: CHRISTOPHER F.REGAN, Allen,Dyer,Doppelt,Milbrath & Gilchrist, P.A., P.O. BOX 3791, Orlando, FL, 32802-3791, US

(73) Assignee: Lucent Technologies Inc., Murray Hill, NJ (US)

(21) Appl. No.: 09/805,453

(22) Filed: Mar. 13, 2001

(51) Int. Cl. H04Q 7/20

(52) U.S. Cl. 455/456; 342/357.11

(57) ABSTRACT

A communications system includes at least one mobile station and a plurality of base stations each transmitting a downlink signal to the at least one mobile station substantially asynchronously from one another. Each base station receives an uplink signal from the at least one mobile station responsive to the downlink signal. Further, each base station has a known position and may determine a round trip delay between transmission of the downlink signal and reception of the uplink signal. The communications system may also include a position determiner for determining a position of the at least one mobile station based upon the round trip delays and the known positions of the base stations.

### FIELD OF THE INVENTION

The present invention relates to the field of telecommunications, and, more particularly, to cellular communications systems.

### BACKGROUND OF THE INVENTION

Cellular communications systems typically include multiple base stations for communicating with mobile stations (e.g., a cellular telephone) in a geographical transmission area. Each base station provides an interface between the mobile station and a telecommunications network which may include land lines, satellites, etc.

Cellular communications systems are based upon various technology standards which dictate how the systems operate. For example, in the United States one of two mobile communications technology standards are typically used, namely the code division multiple access standard (CDMA) or the time division multiple access (TDMA) standard. Yet another standard called the global system for mobile communications (GSM) standard is typically used in Europe.

CDMA is a spread-spectrum technology that allows multiple frequencies to be used simultaneously. CDMA requires that every digital packet of information sent be coded with a unique key. A CDMA receiver responds only to this key and can detect and demodulate the signal associated therewith.

TDMA is also a digital transmission technology standard that allows a number of users to access a single radio-frequency (RF) channel without interference by allocating unique time slots to each user within each channel. The TDMA digital transmission format multiplexes three signals over a single channel to provide greater transmission capacity. For example, each channel may be divided into six time slots, and each of the three signals may be allotted two of the six time slots.

Regardless of the technology standard being used, there are certain functions that are desirable to have in any communications system. In particular, it is advantageous to be able to locate a position of a mobile station for emergency purposes or for billing users according to their location, for example. The CDMA standard lends itself well to such position determination because in CDMA signals are simultaneously transmitted from base stations to the mobile station (i.e., the base stations are synchronized). The mobile station records a time of arrival of each of the signals and can therefore determine how far it is from each of the base stations using known positions of the base stations. Thus, the mobile may determine its own position and relay this information to the telecommunications network.

On the other hand, standards such as TDMA do not provide for synchronous transmission of signals from the base stations to mobile stations. Accordingly, there is presently no method available for determining the location of a mobile station using a TDMA or other asynchronous communications system without resorting to global positioning satellite (GPS) receivers or other position detection systems.

A mobile station locating system and related method is disclosed in U.S. Pat. No. 5,901,358 to Petty et al. This locating system uses a combination of the TDMA, CDMA, and frequency division multiple access (FDMA) standards between various base stations and mobile stations. Nonetheless, this system still requires that the timing of the signals transmitted from the base stations be synchronized to an overlying network, and that the transmission timing of the remote stations be synchronized with the base stations.

### SUMMARY OF THE INVENTION

In view of the foregoing background, it is therefore an object of the invention to provide a communications system and related method for determining a position of a mobile station using TDMA or other asynchronous transmission standards, for example, without the need for GPS or other location systems.

This and other objects, features, and advantages in accordance with the present invention are provided by a communications system including at least one mobile station and a plurality of base stations each transmitting a downlink signal to the at least one mobile station substantially asynchronously from one another. Each base station receives an uplink signal from the at least one mobile station responsive to the downlink signal. Further, each base station has a known position and may determine a round trip delay between transmission of the downlink signal and reception of the uplink signal. The communications system may also include a position determiner for determining a position of the at least one mobile station based upon the round trip delays and the known positions of the base stations.

More specifically, each base station may determine the round trip delay by determining a total time between transmission of the downlink signal and reception of the uplink signal and determining and subtracting a transmission delay and reception delay associated with the base station from the total time to provide the round trip delay. Furthermore, the position determiner may determine the position of the at least one mobile station by considering a transmission and reception delay of the at least one mobile station to be a constant. Determination of the position of the at least one mobile station may be based upon at least one of the following methods, a steepest descent method, a Taylor series expansion, and/or direct equation solving.

Additionally, the plurality of base stations may transmit the downlink signals to the at least one mobile station in a predetermined sequence. The uplink and downlink signals may be based upon a time division multiple access (TDMA) format, for example. Also, the plurality of base stations may include at least three base stations, for example.

A method aspect of the invention is for determining a position of at least one mobile station and includes transmitting a downlink signal from each of a plurality of base stations each having a known position to the at least one mobile station substantially asynchronously from one another. An uplink signal may be received from the at least one mobile station at each of the base stations responsive to the respective downlink signals, and a round trip delay between transmission of the downlink signal and reception of the uplink signal may be determined for each base station. The method may further include determining a position of the at least one mobile station based upon the round trip delays and the known positions of the base stations.

### BRIEF DESCRIPTION OF THE DRAWINGS

FIG. 1 is a schematic block diagram of a cellular communications system according to the invention.

FIG. 2 is a diagram illustrating signal delay between a base station and a mobile station used for position determination according to the invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

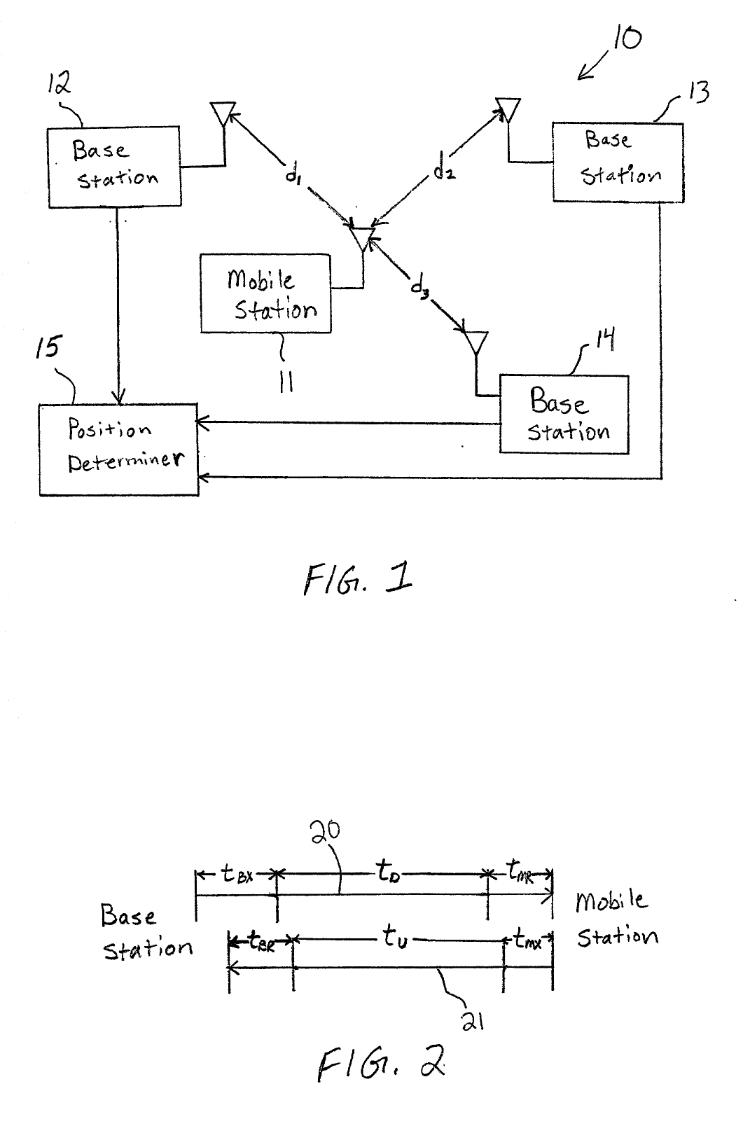

Referring initially to FIG. 1, a communications system 10 according to the present invention is now described. The communications system 10 includes a mobile station 11 and base stations 12, 13, 14 at respective distances d₁, d₂, d₃ from the mobile station. Though a single mobile station 11 is illustrated in FIG. 1 for clarity of explanation, it will be appreciated by those of skill in the art that the communications system 10 according to the present invention may be used with multiple mobile stations. Similarly, it will also be appreciated that other numbers of base stations may be used in accordance with the present invention, though three are illustratively shown.

Each of the base stations 12, 13, 14 may transmit a downlink signal 20 (see FIG. 2) to the mobile station 11 substantially asynchronously from one another. For example, the communications system 10 may use the TDMA standard, as discussed above. Each base station 12, 13, 14 also receives an uplink signal 21 from the mobile station 11 responsive to its downlink signal 20. The base stations 12, 13, 14 also typically have a known position, which may include latitude and longitude coordinates, for example.

Each base station determines a round trip delay between transmission of the downlink signal 20 and reception of the uplink signal 21. Further, the communications system 10 also includes a position determiner 15 for determining a position of the mobile station 11 based upon the round trip delays and the known positions of the base stations 12, 13, 14, as will be explained further below. The position determiner may be a position determination entity (PDE), for example.

According to the standards for TDMA based systems, the base stations 12, 13, 14 send respective downlink signals 20 to the mobile station 11 and the mobile station responds with respective uplink signals 21 each delayed according to a time alignment value. As may be understood more clearly with reference to FIG. 2, the base stations 12, 13, 14 and the mobile station 11 have respective transmission delays t_{BX}, t_{MX} and reception delays t_{BR}, t_{MR} associated therewith. These delays may be caused by the hardware in each of the base stations 12, 13, 14 and mobile station 11, for example.

Thus, a total time between transmission of each downlink signal 20 and reception of the respective uplink signal 21 may be determined by adding the transmission delays t_{BX}, t_{MX}, reception delays t_{BR}, t_{MR}, and downlink and uplink transmission times t_{D}, t_{U}. The downlink and uplink signals 20, 21 travel at approximately the speed of light c. It will be assumed herein that the delay associated with the time alignment value at the mobile station is included in the transmission delay t_{MX} for simplification.

Accordingly, to determine the round trip delay, each base station may measure its own transmission and reception delays t_{BX}, t_{BR}, and subtract these delays from the total time to provide the round trip delay to the position determiner 15. Of course, the base stations 12, 13, 14 may alternately transmit both the total time and the measured transmission and reception delays t_{BX}, t_{BR} to the position determiner 15 which may perform the subtraction. Thus, as used herein, the term “round trip delay” is intended to cover both of these alternatives. Measurement of the transmission and reception delays t_{BX}, t_{BR} may be performed, for example, using the method disclosed in U.S. patent application Ser. No. 09/360,574, assigned to the present assignee, which is hereby incorporated herein in its entirety by reference.

For the sake of discussion, it will be assumed herein that the transmission and reception delays t_{BX}, t_{BR} associated with the base stations 12, 13, 14 are subtracted from the total time at the respective base stations. Each round trip delay therefore includes the transmission times t_{D}, t_{U} and the transmission and reception delays t_{MX}, t_{MR} of the mobile station 11. The transmission and reception delays t_{MX}, t_{MR} may be considered to be constant, which in practice proves to be a good approximation. Thus, the transmission and reception delays t_{MX}, t_{MR} may be formulated as an unknown in time of arrival equations and may be determined upon solving these equations, as will be discussed further below.

To determine the position of the mobile station 11 in two dimensions and to solve for the transmission and reception delays t_{MX}, t_{MR}, the round trip delays and known locations of the base stations 12, 13, 14 are used. These round trip delays may be determined by transmitting the downlink signal 20 from each of the base stations 12, 13, 14 to the mobile station 11 in a predetermined sequence. That is, one of the base stations 12, 13, 14 determines its round trip delay, and then the mobile station 11 is “handed off” to another one of the base stations to determine its round trip delay and so on. According to the TDMA standard, synchronization between the base stations 12, 13, 14 is not necessary since each base station will individually synchronize itself with the mobile station 11.

Expressing the known position of the base stations 12, 13, 14 as (x1, y1), (x2, y2) and (x3, y3), respectively, the coordinates of the mobile station 11 as (x, y), and the round trip delays between the base stations 12, 13, 14 and the mobile station 11 as rd1, rd2, and rd3, respectively, time of arrival equations for each base station may be modeled as follows:

$$\begin{matrix}\sqrt{{( x - x1 )}^{2} + {( y - y1 )}^{2}} = \frac{( ( rd1 * c ) - ( {t}_{MR} + {t}_{MX} ) * c )}{2} , & ( 1 ) \\ \sqrt{{( x - x2 )}^{2} + {( y - y2 )}^{2}} = \frac{( ( rd2 * c ) - ( {t}_{MR} + {t}_{MX} ) * c )}{2} , and & ( 2 ) \\ \sqrt{{( x - x3 )}^{2} + {( y - y3 )}^{2}} = \frac{( ( rd3 * c ) - ( {t}_{MR} + {t}_{MX} ) * c )}{2} . & ( 3 )\end{matrix}$$

The above equations assume that the transmission and reception delays t_{BX}, t_{BR} have already been subtracted out from the round trip delays. Again, it is also assumed that the delay experienced at the mobile station 11 (i.e., t_{MX}+t_{MR}) is constant. Subtracting equations (1) from (2) and (3), the mobile station 11 delay t_{MX}+t_{MR} may be eliminated, which results in the following equations:

\sqrt{(x−x2)²+(y−y2)²}−\sqrt{(x−x1)²+(y−y1)²}=(rd2*c−rd1*c), (4)

and

\sqrt{(x−x3)²+(y−y3)²}−\sqrt{(x−x1)²+(y−y1)²}=(rd3*c−rd1*c). (5)

The equations (4) and (5) may be solved by the position determiner 15 to provide the position of the mobile station 11 iteratively using the steepest descent method, a Taylor series expansion, or directly, for example, as will be appreciated by those of skill in the art. Of course, once the position (x, y) of the mobile station 11 is determined, this position may be substituted back into equations (1)-(3) to solve for the delay t_{MX}+t_{MR}. This delay may then be used for future position determination for the mobile station 11 to simplify processing.

When using three or more base stations, the accuracy of the mobile station 11 position determination will of course depend upon a number of factors. First, the accuracy will depend upon the speed at which the mobile station 11 is traveling. Obviously, the faster the mobile station 11 is traveling, the less accurate the position determination will be. Similarly, the longer the hand off time between the base stations, the less accurate the position determination will be (assuming that the mobile station 11 is moving). Thus, if a base station or mobile station 11 has a particularly long delay associated therewith, accuracy could diminish. Of course, variation in the delays t_{MX} and t_{MR} may also reduce accuracy. Nonetheless, according to the present invention position determinations of about a few hundred yards or less may be obtained for mobile stations traveling at highway speeds, and even greater accuracy may be obtained for stationary mobile stations.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that other modifications and embodiments are intended to be included within the scope of the appended claims.

That which is claimed is:

1. A communications system comprising:
at least one mobile station;
a plurality of base stations each transmitting a downlink signal to said at least one mobile station substantially asynchronously from one another and receiving an uplink signal from said at least one mobile station responsive thereto, each base station having a known position and determining a round trip delay between transmission of the downlink signal and reception of the uplink signal; and
a position determiner for determining a position of said at least one mobile station based upon the round trip delays and the known positions of said base stations.

2. The communications system of claim 1 wherein each base station determines the round trip delay by:
determining a total time between transmission of the downlink signal and reception of the uplink signal; and
determining and subtracting a transmission delay and reception delay associated with said base station from the total time to provide the round trip delay.

3. The communications system of claim 1 wherein said position determiner determines the position of said at least one mobile station by considering a transmission and reception delay of said at least one mobile station to be a constant.

4. The communications system of claim 3 wherein said position determiner determines the position of said at least one mobile station based upon at least one of a steepest descent method, a Taylor series expansion, and directly.

5. The communications system of claim 1 wherein the plurality of base stations transmit the downlink signals to said at least one mobile station in a predetermined sequence.

6. The communications system of claim 1 wherein said plurality of base stations comprises at least three base stations.

7. The communications system of claim 1 wherein the uplink and downlink signals are based upon a time division multiple access (TDMA) format.

8. A time division multiple access (TDMA) communications system comprising:
at least one mobile station;
a plurality of base stations each transmitting a downlink signal to said at least one mobile station substantially asynchronously from one another in a predetermined sequence and receiving an uplink signal from said at least one mobile station responsive thereto, each base station having a known position and determining a round trip delay between transmission of the downlink signal and reception of the uplink signal; and
a position determiner for determining a position of said at least one mobile station based upon the round trip delays and the known positions of said base stations.

9. The TDMA communications system of claim 8 wherein each base station determines the round trip delay by:
determining a total time between transmission of the downlink signal and reception of the uplink signal; and
determining and subtracting a transmission delay and reception delay associated with said base station from the total time to provide the round trip delay.

10. The TDMA communications system of claim 8 wherein said position determiner determines the position of said at least one mobile station by considering a transmission and reception delay of said at least one mobile station to be a constant.

11. The TDMA communications system of claim 10 wherein said position determiner determines the position of said at least one mobile station based upon at least one of a steepest descent method, a Taylor series expansion, and directly.

12. The TDMA communications system of claim 8 wherein said plurality of base stations comprises at least three base stations.

13. A method for determining a position of at least one mobile station comprising:
transmitting a downlink signal from each of a plurality of base stations each having a known position to the at least one mobile station substantially asynchronously from one another;
receiving an uplink signal from the at least one mobile station at each of the base stations responsive to the respective downlink signals;
determining a round trip delay between transmission of the downlink signal and reception of the uplink signal for each base station; and
determining a position of the at least one mobile station based upon the round trip delays and the known positions of the base stations.

14. The method of claim 13 wherein determining the round trip delay comprises:
determining a total time between transmission of the downlink signal and reception of the uplink signal for each base station; and
determining and subtracting a transmission delay and reception delay associated with each base station from the respective total time to provide the round trip delay.

15. The method of claim 13 wherein determining the position of the at least one mobile station comprises considering a transmission and reception delay of the at least one mobile station to be a constant.

16. The method of claim 15 wherein determining the position of the at least one mobile station comprises determining the position based upon at least one of a steepest descent method, a Taylor series expansion, and directly.

17. The method of claim 13 wherein transmitting comprises transmitting the downlink signals to the at least one mobile station in a predetermined sequence.

18. The method of claim 13 wherein the plurality of base stations comprises at least three base stations.

19. The method of claim 13 wherein the uplink and downlink signals are based upon a time division multiple access (TDMA) format.

20. A method for determining a position of at least one mobile station in a time division multiple access (TDMA) communications system comprising:
transmitting a downlink signal from each of a plurality of base stations each having a known position to the at least one mobile station substantially asynchronously from one another in a predetermined sequence;
receiving an uplink signal from the at least one mobile station at each of the base stations responsive to the respective downlink signals;
determining a round trip delay between transmission of the downlink signal and reception of the uplink signal for each base station; and
determining a position of the at least one mobile station based upon the round trip delays and the known positions of the base stations.

21. The method of claim 20 wherein determining the round trip delay comprises:
determining a total time between transmission of the downlink signal and reception of the uplink signal for each base station; and
determining and subtracting a transmission delay and reception delay associated with each base station from the respective total time to provide the round trip delay.

22. The method of claim 20 wherein determining the position of the at least one mobile station comprises considering a transmission and reception delay of the at least one mobile station to be a constant.

23. The method of claim 22 wherein determining the position of the at least one mobile station comprises determining the position based upon at least one of a steepest descent method, a Taylor series expansion, and directly.

24. The method of claim 20 wherein the plurality of base stations comprises at least three base stations.
